(19) United States
(12) Patent Application Publication
(10) Pub. No.: US 2012/0260613 A1
(43) Pub. Date: Oct. 18, 2012

(54) CONTAINERS

(76) Inventors: Aaron Lewis Holder, Christchurch (NZ); Irwin Charles Holder, North Canterbury (NZ); Jason Robert Tobin, Christchurch (NZ)

(21) Appl. No.: 13/453,794

(22) Filed: Apr. 23, 2012

Related U.S. Application Data
(63) Continuation-in-part of application No. 12/747,989, filed on Aug. 4, 2010.

(30) Foreign Application Priority Data
Dec. 14, 2007 (NZ) 561599

(51) Int. Cl. B65D 17/34; B26F 1/02

(52) U.S. Cl. 53/492; 220/270; 220/89.1

(57) ABSTRACT

A container includes a lid having a first breachable portion and a second breachable portion, the first breachable portion being breachable to permit passage of the container contents therethrough; the second breachable portion separate to the first, the second breachable portion being breachable to allow at least partial depressurisation of the container; a single piece opening member attached to the lid and rotatable about the attachment between a first non-breaching position and a second breaching position, the single piece opening member forming a lever having a first end for impinging on the first breachable portion; and a second end of the single piece opening member includes a protrusion, upon rotation of the single piece opening member to the second breaching position and upon a downward application of force of impinging on and breaching the second breachable portion, the protrusion equalising pressure between the container contents and the external environment.

### RELATED APPLICATION

The present application is a Continuation in Part, and claims priority pursuant to 35 USC 120 based on U.S. Ser. No. 12/747,989 filed Aug. 4, 2010, which is a 371 of PCT/NZ08/00330, filed Dec. 12, 2008, claiming priority from New Zealand 561599, filed Dec. 14, 2007.

### TECHNICAL FIELD

The present invention relates to improvements in containers.

In particular, the present invention relates to an improved container and method of opening for equalising pressure before accessing the contents.

### BACKGROUND

To aid clarity and to avoid prolixity the present invention will be described herein with respect to containers in the form of soft-drink cans or the like for which the present application has particular application. However, it should be appreciated that the present invention may also relate to other sealed containers having pressurised contents for which rapid and/or violent depressurisation is undesirable.

Soft-drinks and other canned beverages containing carbonated fluid provide the quintessential bubbles which appeal to many people. In order to create such carbonated fluid, carbon dioxide is dissolved under pressure in the fluid before being sealed inside an aluminium can, plastic or glass bottle or other sealed container.

When the container is opened, the carbon dioxide is allowed to expand and forms as bubbles in the fluid.

Agitation of the container before opening leads to nucleation of the gas in the fluid. This agitation creates regions of fluid at different pressure and diffuses the gas molecules through the fluid. The molecules thus collect together during the diffusion to form clusters of gas which expand into bubbles when the container is opened and the fluid is depressurised. Sufficient agitation and rapid depressurisation can also lead to egression of fluid as frothy foam and/or spray when the container is opened.

There is not only a fluid loss during opening but also the inconvenience of having uncontrolled fluid expulsion. To alleviate these problems the container may be rested and the fluid left to return to equilibrium over an extended period of time, or alternatively, in the case of bottles having screw-caps, the cap may be opened slightly to reduce the rate of depressurisation until the pressure has equalised with the external environment.

However, the latter method cannot be used for cans and many other sealed containers. For example, cans typically have a pull-tab used to breach a scored region of the can lid. The only means of reducing the depressurisation rate for such cans is to breach only a small portion of the scoring which thus requires careful manipulation of the pull-tab by the user. This manipulation may be beyond the skill or dexterity of many people and thus there is a need for an improved method.

Similar problems are encountered with beer, sparkling wine and other fermented beverages which contain gas dissolved in a fluid.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### SUMMARY

1. According to a first aspect of the present invention there is provided a container, comprising:
a lid having a first breachable portion and a second breachable portion;
said first breachable portion capable of being breached to permit passage of the container contents therethrough;
said second breachable portion separate to the first, the second breachable portion capable of being breached to allow at least partial depressurisation of the container;
a single piece opening member attached to said lid and rotatable about said attachment between a first non-breaching position and a second breaching position, the single piece opening member forming a lever having a first end for impinging on the first breachable portion to breach same; and
   a second end of said single piece opening member which includes a protrusion capable upon rotation of the single piece opening member to the second breaching position and upon a downward application of force of impinging on and breaching the second breachable portion on the container lid to equalise pressure between the container contents and the external environment.

According to one aspect of the present invention at least one said breachable portion is irreversibly breachable.

Preferably both said breachable portions are breachable by said opening member.

Preferably breaching of either the first or second breachable portions permits complete depressurisation of the container.

As referred to herein, the term “breachable portion” refers to any frangible or weakened portion of the container (or a lid of the container) that is capable of being ruptured, broken or otherwise breached in order to provide an opening to permit passage of the container contents.

Preferably the container is an aluminium can.

Preferably the container includes:
a lid having the first and second breachable portions;
the opening member attached to the lid and having a first end for impinging on the first breachable portion to breach same, and
   characterised in that said opening member includes a protrusion capable of impinging on and breaching the second breachable portion to equalise pressure between the container contents and the external environment.

The pull tab is rotatable about the point of attachment between the pull tab and the container. Rotation of the pull tab about its point of connection with the container allows the protrusion on the pull tab to be positioned in a non-breaching position where the protrusion is not positioned over a breachable portion of the container and a breaching position whereby the protrusion is positioned over a breachable portion of the container.

The ability to position the pull tab in a default non-breaching position allows transportation of containers fitted with the pull tab of the present invention with minimal risk of accidental breaching of the second breachable portion. When the contents of the container are intended to be consumed the pull tab is easily rotated into a breachable position whereby downward pressure on the pull tab results in the protrusion breaching the second breachable portion.

Preferably the protrusion is offset from the median plane of the pull tap. An offset protrusion allows the default position of the pull tab to be substantially equivalent to the position of a standard pull tab.

Preferably at least one said breachable portion is formed by scoring the container lid about at least part of a region defining the, or each, breachable portion. Pressure of the opening member on the region bound by the scoring may thus breach the breachable portion to provide an opening to the container contents.

It is preferable that a portion of the boundary is un-scored to prevent the entire breachable portion of lid from being detached, and passing into the container. A detachable breachable portion may contaminate the container contents and/or interfere with the user during drinking from the container.

In another embodiment at least one said breachable portion is formed from a relatively thinner portion of material than the surrounding lid.

In yet another embodiment at least one said breachable portion is formed from a relatively weaker portion of material than the surrounding lid.

Preferably the second breachable portion is substantially rectilinear.

In one preferred embodiment the second breachable portion includes a perimeter comprising two opposing sides and a curved end connecting the two opposing sides.

Preferably the second breachable portion has a smaller surface area than the first breachable portion.

Preferably the second breachable portion is less than one fifth of the surface area of the first breachable portion.

Preferably the area of the second breachable portion is less than approximately 2.4×10⁻⁵ m².

Preferably the second breachable portion is substantially rectilinear.

Preferably the opening member is a ‘pull-tab’ as utilised on known soft-drink cans.

According to another aspect of the present invention there is provided a pull-tab for attachment to a container substantially as hereinbefore described, the pull-tab including:
a first end for impinging on the first breachable portion to breach same, and
   characterised in that said pull-tab includes a protrusion capable of impinging on and breaching the second breachable portion to equalise pressure between the container contents and the external environment.

Preferably the protrusion is formed integrally with the pull-tab. The protrusion may thus be formed during the moulding and folding process of typical pull-tabs alleviating the need for retrofitting of additional members.

According to another aspect of the present invention there is provided a container lid for a container substantially as hereinbefore described, the container lid including:
a first breachable portion and a second breachable portion;
an opening member, formed as a single piece, attached to the container lid by, and being rotatable about, an attachment, the pull tab capable of being rotated between a first non-breaching position and a second breaching position, the single piece opening member forming a lever and having a first end for impinging on the first breachable portion to breach same, and
   a second end of the single piece opening member which includes a protrusion capable upon a downward application of force of impinging on and breaching the second breachable portion on the container lid when the single piece opening member is positioned in the second breaching position to equalise pressure between the container contents and the external environment.

According to another aspect of the present invention there is provided a method of opening a container as claimed in any one of the previous claims, said method including the steps of:
rotating the single piece opening member to the second breaching position; and
breaching the second breachable portion to at least partially depressurise the container; and
breaching the first breachable portion to permit passage of the container contents.

The present invention may thus provide significant advantages over the prior art, including provision of a container capable of a controlled depressurisation before opening the first breachable portion and thereby ameliorate the risk of rapid depressurisation and egression of the container contents out of the main breachable portion.

### BRIEF DESCRIPTION OF THE DRAWINGS

Further aspects and advantages of the present invention will become apparent from the following description which is given by way of example only and with reference to the accompanying drawings in which:

FIG. 1 Shows a side perspective view of a container according to one preferred embodiment of the present invention; and,

FIG. 2 Shows a side perspective view of the container of FIG. 1 with the second breachable portion breached.

### DETAILED DESCRIPTION

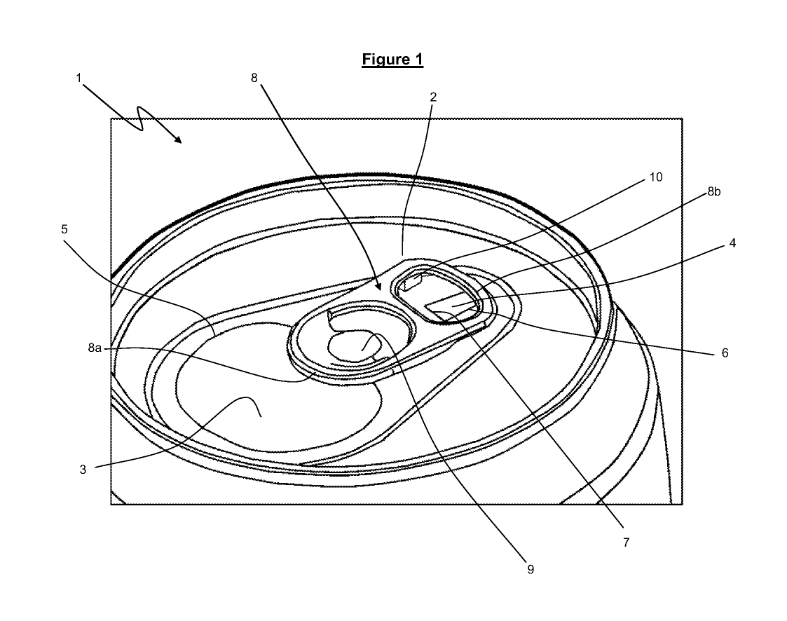

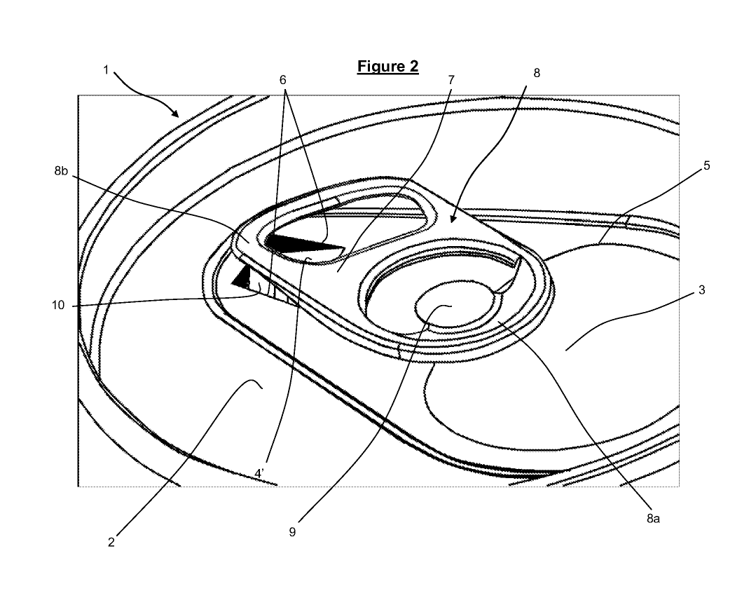

FIGS. 1 and 2 show a container according to one preferred embodiment in the form of an aluminium soft drink can as generally indicated by arrow 1.

It will be readily appreciated by one skilled in the art that numerous embodiments are possible and that the example of an aluminium soft drink can is purely exemplary and in no way limiting.

The soft drink can (1) is generally cylindrical and has a lid (2) with first and second breachable portions (3, 4) formed by scoring a region of the can lid (2) along peripheral boundaries (5, 6) around the breachable portions (3, 4). The scoring (5, 6) provides a weakened region which will rupture when sufficient pressure is placed on each breachable portion (3, 4).

The first breachable portion (3) is significantly larger than the second breachable portion (4) to allow a user to pour the contents of the can (1). The second breachable portion (4) is smaller to allow depressurisation without significant egression of the can (1) contents.

The second breachable portion (4) includes two scored sides (6), a scored curved end (not shown) and one un-scored side (7) which, when the second breachable portion (4) is breached, acts as a hinge to retain the breachable portion (4) of lid (2) and prevents the breached portion (4′) from falling into the can (1).

The exemplary can (1) shown in FIGS. 1 and 2 is sized such that the two scored sides (6) are approximately 6.5 mm in length and separated by the un-scored side of length approximately 3.8 mm, although it will be appreciated the dimensions of the breachable portions (3, 4) may be adapted to suit the particular container.

A pull-tab (8) is riveted to the lid (2) with a rivet (9) between the two breachable portions (3, 4) and is rotatable about said rivet between a first non-breaching position, shown in FIG. 1, and a second breaching position, shown in FIG. 2. Pull- tab (8) includes a first end (8a) adapted to impinge on and breach the first breachable portion (3) and a second end (8b) having a protrusion (10) which is adapted to breach the second breachable portion (4) when the pull tab (8) is rotated into the second breachable position and is pushed against the second breachable portion (4), as is shown in FIG. 2.

The protrusion (10) is formed during the manufacture of the pull-tab (8) by including additional portions of aluminium on the tab (8) when cast in a die. The additional portions may then be folded together to form the protrusion (10). In the example shown in FIGS. 1 and 2, the protrusion (10) extends approximately 4 mm from the pull-tab second end (8b) and is approximately 3 mm wide at its widest point.

The protrusion (10) is shown in FIG. 1 and FIG. 2 as being offset from the median plane of the pull tab. However, it will be appreciated that the protrusion could also be positioned on the median plane, in which case the pull tab is typically rotated away from the second breaching position, during transport for example. The protrusion (10) is formed on the innermost side of the second end (8b) so that the outer side is easily gripped by a user when pulling upwards to open the first breachable portion (3).

To open the can (1), the pull tab (8) is rotated about attachment rivet (9) from the first non-breaching position, shown in FIG. 1, into the second breaching position, shown in FIG. 2, and the second end (8b) of the pull-tab (8) is pressed onto the second breachable portion (4) to breach same and thereby allow depressurisation of the can (1). The pull-tab (8) is then pulled away from the second breachable portion (4) to force the first end (8a) into contact with the first breachable portion (3) to breach same.

Thus, by providing a second breachable portion (4) which is relatively small, the can (1) may be depressurised at a controlled slower rate than breaching the first breachable portion (3). In contrast, existing soft drink cans only have a ‘first breachable portion’ which when opened can lead to rapid depressurisation of the can and therefore rapid egression of the contents i.e. a shaken can will often froth and spill drink when opened.

Aspects of the present invention have been described by way of example only and it should be appreciated that modifications and additions may be made thereto without departing from the scope thereof.

What we claim is:

1. A container, comprising:
a lid having a first breachable portion and a second breachable portion;
said first breachable portion capable of being breached to permit passage of the container contents therethrough;
said second breachable portion separate to the first, the second breachable portion capable of being breached to allow at least partial depressurisation of the container;
a single piece opening member attached to said lid and rotatable about said attachment between a first non-breaching position and a second breaching position, the single piece opening member forming a lever having a first end for impinging on the first breachable portion to breach same; and
a second end of said single piece opening member which includes a protrusion, upon rotation of the single piece opening member to the second breaching position and upon a downward application of force of impinging on and breaching the second breachable portion on the container lid, said protrusion equalising pressure between the container contents and the external environment.

2. The container as claimed in claim 1, wherein the container is an aluminium can.

3. The container as claimed in claim 1, wherein the first breachable portion is formed by scoring the container lid about a region defining the first breachable portion.

4. The container as claimed in claim 1, wherein the second breachable potion is formed by scoring the container lid about a region defining the second breachable portion.

5. The container as claimed in claim 1, wherein the first breachable portion is formed from a relatively thinner portion of material than the surrounding lid.

6. The container as claimed in claim 1, wherein the second breachable potion is formed from a relatively thinner portion of material than the surrounding lid.

7. The container as claimed in claim 1, wherein the first breachable portion is formed from a relatively weaker portion of material than the surrounding lid.

8. The container as claimed in claim 1, wherein the second breachable portion is formed from a relatively weaker portion of material than the surrounding lid.

9. The container as claimed in claim 1, wherein the second breachable portion is smaller than the first breachable portion.

10. The container as claimed in claim 9, wherein the second breachable portion is less than one fifth of the size of the first breachable portion.

11. The container as claimed in claim 7, wherein the area of the second breachable portion is less than approximately 1.6×10⁻⁵ m².

12. The container as claimed in claim 1, wherein the second breachable portion is rectilinear.

13. The container as claimed in claim 1, wherein the opening member is a ‘pull-tab’.

14. The container as claimed in claim 1, wherein the opening member is a ‘pull-tab’ and wherein the protrusion is offset from a median plane of the pull-tab.

15. A single piece pull-tab for attachment to a container having a first breachable portion and a second breachable portion, the single piece pull-tab comprising:
an attachment point for attaching the pull-tab to the container so that when the pull tab is connected to a container it functions as a lever and can be rotated about the point of attachment;
a first end configured for impinging on the first breachable portion on the container to breach same; and
a second end of said single piece pull-tab includes a protrusion configured to, upon rotation of the single piece opening member to the second breaching position and upon a downward application of force, impinge on and breach the second breachable portion on the container to equalise pressure between the container contents and the external environment.

16. The single piece pull-tab as claimed in claim 15, wherein the protrusion is formed integrally with the single piece pull-tab.

17. The single piece pull-tab as claimed in claim 15, wherein the protrusion is offset from a median plane of the pull-tab.

18. A container lid for a container comprising:
a first breachable portion and a second breachable portion;
an opening member formed as a single piece, attached to said lid by, and being rotatable about an attachment, the pull tab capable of being rotated between a first non-breaching position and a second breaching position, the single piece opening member forming a lever and having a first end for impinging on the first breachable portion to breach same; and
a second end of the single piece opening member which includes a protrusion, upon a downward application of force said protrusion impinging on and breaching the second breachable portion on the container lid when the single piece opening member is positioned in the second breaching position to equalise pressure between the container contents and the external environment.

19. The container lid as claimed in claim 18, wherein the protrusion is offset from the median plane of the pull-tab.

20. A method of opening a container as claimed in claim 1, said method comprising the steps of:
rotating the single piece opening member to the second breaching position; and
pushing downward on a tab portion adjacent the second breachable portion of the can, breaching the second breachable portion to at least partially depressurise the container; and,
pulling upward on the end of the tab opposite the first breachable portion of the can, breaching the first breachable portion of the can to permit passage of the container contents.
